(19) United States
(12) Patent Application Publication
(10) Pub. No.: US 2014/0368743 A1
(43) Pub. Date: Dec. 18, 2014

(54) MULTIPLE WI-FI ATSC TV ANTENNA RECEIVER

(71) Applicant: Lin Yang, Milpitas, CA (US)

(72) Inventor: Lin Yang, Milpitas, CA (US)

(21) Appl. No.: 13/918,803

(22) Filed: Jun. 14, 2013

(51) Int. Cl. H04N 5/44

(52) U.S. Cl. CPC H04N 5/44
USPC 348/731

(57) ABSTRACT

A device is provided. The device comprises of a waveform decompression decoder, Signal-to-noise ratio (SNR) Weighted Combining unit for multiple antennas, Frequency Domain Maximum Ratio Combining (MRC) Equalizer, Time Domain Maximum Ratio Combining (MRC) Equalizer, Equal Gain Combining Unit, and Selective Combining Slicer. The method for producing the device is also provided.

### TECHNICAL FIELD

The present invention relates generally to an application in a digital television system, more specifically the present invention relates to a multiple antenna ATSC terrestrial DTV receiver for indoor and mobile users.

### BACKGROUND

Single carrier terrestrial digital television (DTV) systems (ATSC) are deployed in the countries such as United States, Canada, and other countries.

ATSC HDTV signals are subject to multipath with Doppler interference in indoor, outdoor, and mobile environments.

Currently, only single-antenna ATSC HDTV receivers exist. For existing single-antenna applications, an equalizer can be used to remove the static multipath interference.

To improve reception, multiple antennas should be used. However, no existing ATSC HDTV receiver can efficiently combine multiple antenna signals to make it perform better than a single antenna. This is because the multiple Doppler multipath generated by the multiple antennas are cross-interfering.

This invention is a means to build a receiver device that optimally combines the signals from multiple antennas, which removes multiple multipath (with or without Doppler) interference and enhances the ATSC HDTV signal reception in indoor, outdoor, and mobile environments.

The television antenna has existed for decades, and has traditionally been mounted on rooftops and connected to the TV with a long wire. TVs have become thinner, sleeker, and available in more formats (portable TV, tablet, cell phone, etc.). The wired connection between the antenna and the above-mentioned TV-viewing device needs to be replaced with a wireless connection to cater to these new formats.

Additionally, recent advances in Wi-Fi technology have enabled very high speed transfer rates (1 Gbps). Due to this high speed, Wi-Fi now has the means to wirelessly connect single or multiple antennas to the TV viewing device.

The following patents are herein incorporated by reference: U.S. patent application Ser. No. 13/871869 entitled WI-Fl ATSC TV ANTENNA, by Yang; U.S. patent application Ser. No. 13/872917 entitled MULTIPLE ANTENNA ATSC HDTV RECEIVER DEVICE, by Yang; U.S. patent application Ser. No. 13/889158 entitled A METHOD OF CHANNEL CHARACTERIZATION FOR MOBILE ATSC HDTV RECEIVER, by Yang; U.S. patent application Ser. No. 13/890097 entitled CHANNEL STATE INFORMATION ASSISTED DECISION FEEDBACK EQUALIZER FOR MOBILE ATSC HDTV RECEIVER, by Yang; U.S. patent application Ser. No. 13/892504 entitled ATSC TERRESTRIAL TV ANTENNA NETWORK, by Yang; U.S. patent application Ser. No. 13/896191 entitled A METHOD OF ATSC MH STREAM ASSISTED CHANNEL CHARACTERIZATION FOR MOBILE ATSC TV RECEIVER, by Yang; U.S. patent application Ser. No. 13/902947 entitled WI-Fl ATSC TV ANTENNA WITH WAVEFORM COMPRESSION, by Yang.

In addition to the above-referenced applications, the present invention adds a new function of waveform compression and decompression to the Wi-Fi TV antenna interface of the receiver.

### SUMMARY OF THE INVENTION

This invention is a Multiple Wi-Fi ATSC TV Antenna Receiver, which comprises of the following functional blocks: Waveform decompression decoder, Signal-to-noise ratio (SNR) Weighted Combining unit for multiple antennas, Frequency Domain Maximum Ratio Combining (MRC) Equalizer, Time Domain Maximum Ratio Combining (MRC) Equalizer, Equal Gain Combining Unit, and Selective Combining Slicer.

### BRIEF DESCRIPTION OF THE DRAWINGS

Having thus described the invention in general terms, reference will now be made to the accompanying drawings, which are not necessarily drawn to scale, and wherein:

FIG. 1 is the Multiple Wi-Fi ATSC TV Antenna Receiver.

FIG. 2 is the Wi-Fi ATSC TV Antenna with Waveform Compression.

FIG. 3 is a Multiple Wi-Fi ATSC TV Antenna for TV, Tablet, Phone, Set-Top-Box, etc.

### DETAILED DESCRIPTION

The present inventions now will be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.

### COMPONENT LIST:

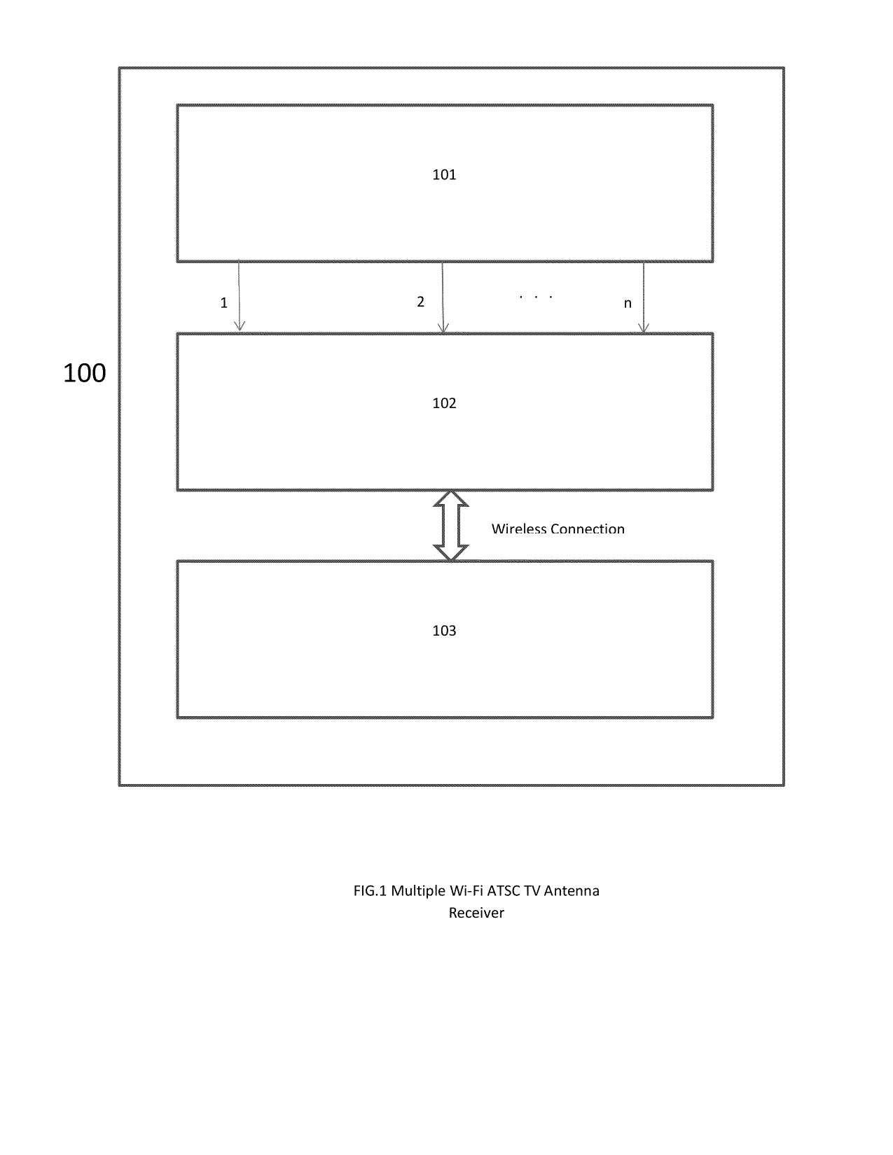

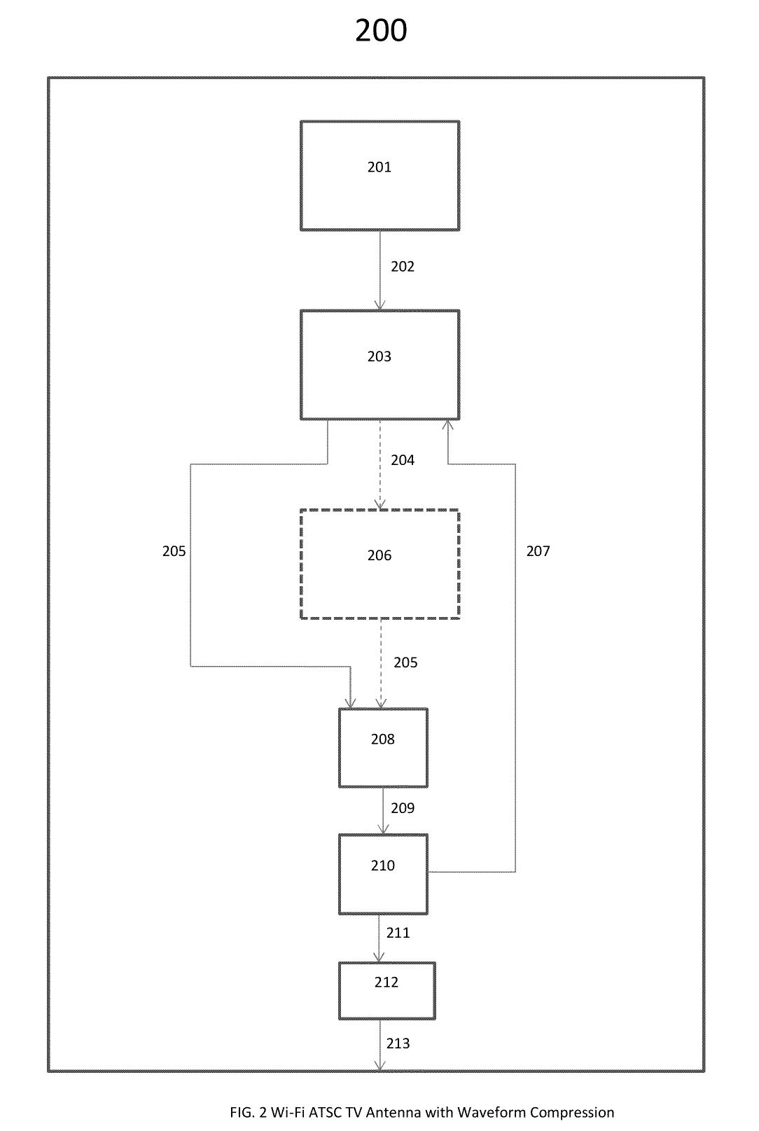

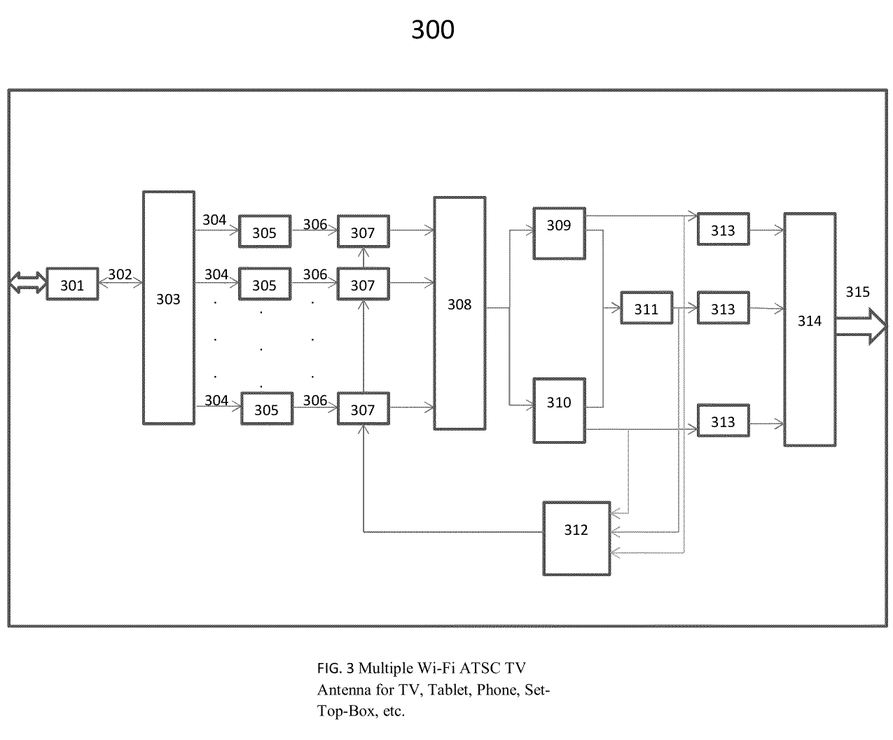

FIG. 1
   100—The Invention
   101—Multiple (one or more) terrestrial TV antennas
   102—Multiple Wi-Fi ATSC TV Antenna Adapters with waveform compression
   103—Multiple Wi-Fi ATSC TV Antennas Receiver with waveform decompression for TV, Tablet, Phone, Set-Top-Box, etc.
FIG. 2
   200—Wi-Fi ATSC TV Antenna with Waveform Compression (example uses a single antenna)
   201—Terrestrial TV Antenna
   202—TV RF Signal Cable (traditionally plugs in to TV)
   203—TV Tuner (CAN, Silicon, etc.)
   204—Analog IF TV Signal
   205—Digital IF TV Signal
   206—Analog to Digital Signal Converter (106 is optional if the ADC is built-in the Tuner)
   207—IF AGC Signal
   208—Waveform Data Compression Unit
   209—Compressed Digital IF TV Signal
   210—TV Signal to Wi-Fi Signal Adapter
   211—Input Signal to Wi-Fi
   212—High Speed Wi-Fi Device
   213—Wi-Fi RF Signal
FIG. 3
   300—Multiple Wi-Fi ATSC TV Antenna for TV, Tablet, Phone, Set-Top-Box, etc.
   301—High Speed Wi-Fi Receiver
   302—Multiplexed Multiple Antenna Digital IF Signal
   303—Multiple antenna IF Signal De-multiplexer and Waveform De-compressor
   304—Single Antenna Digital IF Signal
   305—IF to Baseband down-conversion and signal synchronization. Includes but not limited to frequency shifting, low-pass filter, symbol timing recovery, carrier recovery, SRRC filter, Field Synchronization, segment synchronization
   306—Synchronized Baseband Signal for each antenna
   307—Channel State Estimation and Signal-To-Noise-Ratio (SNR) Estimation for each antenna
   308—Signal-to-noise ratio (SNR) Weighted Combining for multiple antennas
   309—Frequency Domain Maximum Ratio Combining (MRC) Equalizer
   310—Time Domain Maximum Ratio Combining (MRC) Equalizer
   311—Equal Gain Combining Unite
   312—Selective Combining Slicer
   313—Forward Error Correction (FEC) Block: includes Viterbi Decoder, De-interleaver, R.S. Decoder, and De-randomizer
   314—Selective Combining Unit
   315—Output Signal as MPEG TS

This invention is described in FIG. 1.

101 shows Multiple Terrestrial TV Antennas.

102 is Multiple Wi-Fi ATSC TV Antenna Adapters with waveform compression.

103 is Multiple Wi-Fi ATSC TV Antenna Receiver with waveform decompression for TV, Tablet, Phone, Set-Top-Box, etc.

FIG. 2 is an example of the Wi-Fi ATSC TV Antenna (200).

Any terrestrial TV will have a common TV antenna (201) to receive the radio waveforms. Traditionally, the TV antenna is directly plugged in to the TV thru a TV RF signal cable (202). In this invention, the TV RF signal from the antenna is first connected to the TV tuner (203), which traditionally is inside the TV.

This invention has separated the tuner from the TV console, and put the tuner on the antenna side.

If the tuner has an ADC (Analog to Digital Converter) built in, then the output IF ATSC TV signal of the tuner is in digital format (205). If the tuner does not have an ADC built in, then the output IF ATSC TV signal of the tuner is in analog format (204). So, the analog IF ATSC TV signal (204) will be transformed to digital format by the ADC (206).

The tuner needs an IF AGC (Automatic Gain Control) signal (207) to control the tuner's signal dynamic range.

The Digital IF TV Signal (205) is a sampled waveform. The minimum sampling frequency (Nyquist Sampling Rate) is two times the ATSC TV signal baseband symbol rate which is 10.76 MSPS (Mega Symbols per Second). Any sampling frequency above the minimum sampling frequency can be used. In this example, the sampling frequency is 25 MHz and the ADC is 12-bit, therefore the Digital IF TV Signal (205) data rate is 300 Mbps (Mega Bits per Second). Since the bandwidth of the ATSC TV signal is 6 MHz, there is redundant information in the sampled digital IF TV signal (205). The waveform data compression unit (208) is applied to the sampled digital IF TV signal (205) in order to remove the redundancy and reduce the data rate of the signal.

The waveform data compression algorithm in 208 can be either the ADPCM (Adaptive Differential Pulse-Code Modulation) algorithm or the DPCM (Differential Pulse-Code Modulation) algorithm. For this example, the ADPCM algorithm is used. The output of the Waveform Data Compression Unit (208) is a Compressed Digital IF TV Signal (209) with the data rate of 100 Mbps. The Compressed Digital IF TV Signal (209) is fed in to the TV to Wi-Fi Adapter (210).

The TV to Wi-Fi Adapter (210) generates a Wi-Fi interface digital signal (211). This signal directly feeds in to the high speed Wi-Fi RF signal generator (212). The output is the Wi-Fi RF Signal (213). The TV to Wi-Fi Adapter (210) also generates an AGC signal (207) for the tuner (203).

FIG. 3 shows 300, a Multiple Wi-Fi ATSC TV Antennas Receiver with waveform decompression for TV, Tablet, Phone, Set-Top-Box, etc.

301 converts the received Wi-Fi signal in to a multiplexed multiple antennas digital IF signals (302), feeds in to the de-multiplexer and waveform de-compressor (303). The de-multiplexed single antenna digital IF signal was compressed using ADPCM encoder algorithm as described above in FIG. 2. The de-compressor is composed of ADPCM decoder algorithm to restore the original ATSC digital IF signal for each antenna (304).

Each digital IF signal (304) will feed in to 305. This generates a synchronized baseband signal for each antenna (306).

Given a baseband signal from each antenna (306), and the feedback signal from 312, 307 will estimate what the multipath channel looks like and analyze the multipath character and signal-to-noise ratio for each antenna.

Based on the results from each 307, 308 performs weighted combining for normalization of signal-to-noise ratio from multiple antennas based on a newly invented algorithm. This is a new component compared to existing single antenna ATSC HDTV receivers because multiple antennas require weighted combining prior to maximum ratio combining.

The weighted combined signal from 308 will feed in to both the newly invented frequency domain maximum ratio combining equalizer (309) and the newly invented time domain maximum ratio combining equalizer (310). Then, the results from the two equalizers (309 and 310) will be further combined using a newly invented equal gain combining unit (311) to generate an optimal time and frequency domain combined signal.

Now there are three signals from 309, 310 and 311—these three signals will pass through the newly invented selective combining slicer (312) to generate optimal feedback to 307. These three signals will also simultaneously pass thru 313 (feed forward path).

Now use the selective combining unit (314) to pick the best one output of the three (frequency, time, equal gain). Output will be MPEG TS (315).

What is claimed is:

1. A multiple antenna ATSC HDTV receiver device comprising of:
a. A Waveform decompression decoder,
b. A Signal-to-noise ratio (SNR) Weighted Combining unit for multiple antennas,
c. A Frequency Domain Maximum Ratio Combining (MRC) Equalizer,
d. A Time Domain Maximum Ratio Combining (MRC) Equalizer,
e. An Equal Gain Combining Unit, and
f. A Selective Combining Slicer.

2. The device of claim 1 is associated with one or more Wi-Fi ATSC TV antennas with waveform compression.

3. The device of claim 1 is associated with one or more Wi-Fi ATSC TV antennas.

4. The device of claim 1, wherein the device is used in a digital TV receiver (e.g. TV, Set Top Box, etc.).

5. The device of claim 1, wherein the device is used in a mobile terrestrial digital TV receiver (e.g. Tablet, Cell Phone, Laptop, etc.).

6. A method providing:
a. A Function of Waveform decompression decoder,
b. A Function of Signal-to-noise ratio (SNR) Weighted Combining unit for multiple antennas,
c. A Function of Frequency Domain Maximum Ratio Combining (MRC) Equalizer,
d. A Function of A Time Domain Maximum Ratio Combining (MRC) Equalizer,
e. A Function of Equal Gain Combining Unit, and
f. A Function of Selective Combining Slicer.

7. The method of claim 6 is applied to one or more Wi-Fi ATSC TV antennas with waveform compression.

8. The method of claim 6 is applied to one or more Wi-Fi ATSC TV antennas.

9. The method of claim 6 is applied to a digital TV receiver (e.g. TV, Set Top Box, etc.).

10. The method of claim 6 is applied to a mobile terrestrial digital TV receiver (e.g. Tablet, Cell Phone, Laptop, etc.).
